(19) United States
(12) Patent Application Publication
(10) Pub. No.: US 2021/0201886 A1
(43) Pub. Date: Jul. 1, 2021

(54) METHOD AND DEVICE FOR DIALOGUE WITH VIRTUAL OBJECT, CLIENT END, AND STORAGE MEDIUM

(71) Applicant: Beijing Baidu Netcom Science and Technology Co., Ltd., Beijing (CN)

(72) Inventors: Tonghui Li, Beijing (CN); Tianshu Hu, Beijing (CN); Mingming Ma, Beijing (CN); Zhibin Hong, Beijing (CN)

(73) Assignee: Beijing Baidu Netcom Science and Technology Co., Ltd., Beijing (CN)

(21) Appl. No.: 17/204,167

(22) Filed: Mar. 17, 2021

(30) Foreign Application Priority Data
Sep. 14, 2020 (CN) 202010962857.7

(51) Int. Cl. G10L 13/04; G06T 13/40; G06F 40/56; G10L 13/08; G10L 15/26

(52) U.S. Cl. CPC G10L 13/04; G06T 13/40; G10L 15/26; G10L 13/08; G06F 40/56

(57) ABSTRACT

This application discloses a method and a device for dialogue with a virtual object, a client end and a storage medium. A specific implementation scheme of the method applied to the client end includes: converting a first voice collected by the client end into a first text content, in a case that the client end is in an offline mode; acquiring a second text content responding to the first text content based on offline natural language processing (NLP) and/or a target database pre-stored by the client end; performing voice synthesis on the second text content to acquire a second voice; simulating a lip shape of the second voice by using the virtual object to acquire a target video in which the virtual object says the second voice; and playing the target video.

### CROSS-REFERENCE TO RELATED APPLICATION

This application claims a priority to Chinese Patent Application No. 202010962857.7 filed on Sep. 14, 2020, the disclosure of which is incorporated in its entirety by reference herein.

### TECHNICAL FIELD

This application relates to the field of computer technologies, and specifically artificial intelligences, and in particular to a method and a device for dialogue with a virtual object, a client end, and a storage medium.

### BACKGROUND

With the rapid development of artificial intelligences, virtual objects such as virtual characters have been widely applied, one of the applications, for example, is to use a virtual object for dialogue. At present, a solution of dialogue with a virtual object is widely used in various scenarios, such as customer service, host, shopping guide, and so on.

In a dialogue with a virtual object, a video of the dialogue with the virtual object usually needs to be transmitted by virtue of network, which has a relatively high requirement on the network.

### SUMMARY

The present disclosure provides a method and a device for dialogue with a virtual object, a client end, and a storage medium.

According to a first aspect of the present disclosure, a method for dialogue with a virtual object is provided, including:

converting a first voice collected by the client end into a first text content, in a case that the client end is in an offline mode;

acquiring a second text content responding to the first text content based on offline natural language processing (NLP) and/or a target database pre-stored by the client end; wherein the target database stores, in an associated manner, a target text content and a text content responding to the target text content;

performing voice synthesis on the second text content to acquire a second voice;

simulating a lip shape of the second voice by using the virtual object to acquire a target video in which the virtual object says the second voice; and

playing the target video.

According to a second aspect of the present application, a device for dialogue with a virtual object is provided, including:

a conversion module, configured to convert a first voice collected by the client end into a first text content, in a case that the client end is in an offline mode;

an acquisition module, configured to acquire a second text content responding to the first text content based on offline natural language processing (NLP) and/or a target database pre-stored by the client end; wherein the target database stores, in an associated manner, a target text content and a text content responding to the target text content;

a voice synthesis module, configured to perform voice synthesis on the second text content to acquire a second voice;

a lip shape simulation module, configured to simulate a lip shape of the second voice by using the virtual object to acquire a target video in which the virtual object says the second voice; and

a play module, configured to play the target video.

According to a third aspect of the present application, a client end is provided, including:

at least one processor; and

a memory communicatively coupled to the at least one processor;

where, the memory stores thereon an instruction that is executable by the at least one processor, and the instruction, when executed by the at least one processor, causes the at least one processor to perform the method described in the first aspect.

According to a fourth aspect of the present application, there is provided a non-transitory computer-readable storage medium, storing a computer instruction thereon. The computer instruction is configured to be executed to cause a computer to perform the method described in the first aspect.

According to the techniques of the present application, a network transmission problem in a real-time dialogue with a virtual object is solved, and the realization effect of the real-time dialogue with the virtual object is improved.

It should be understood that the content described in this section is not intended to identify critical or important features of the embodiments of the present application, is not intended to limit the scope of the present application. Other features of the present application will be described below to make them easily understood.

### BRIEF DESCRIPTION OF THE DRAWINGS

Drawings are included to provide a better understanding of solutions and are not construed as a limitation to the present application, in the drawings:

FIG. 1 is a schematic flowchart of a method for dialogue with a virtual object according to a first embodiment of the present application;

FIG. 2 is a schematic flowchart of processes implementing a method for dialogue with a virtual object according to an embodiment of the present application;

FIG. 3 is a schematic structural diagram of a device for dialogue with a virtual object according to a second embodiment of the present application; and

FIG. 4 is a block diagram of a client end for implementing the method for dialogue with the virtual object in the embodiment of the present application.

### DETAILED DESCRIPTION

Exemplary embodiments of the present application are described below in conjunction with the drawings, including various details of embodiments of the present application to facilitate understanding, which are considered merely exemplary. Accordingly, one of ordinary skill in the art should appreciate that various changes and modifications may be made to the embodiments described herein without departing from the scope and spirit of the present application. Furthermore, descriptions of well-known functions and structures are omitted from the following description for clarity and conciseness.

### First Embodiment

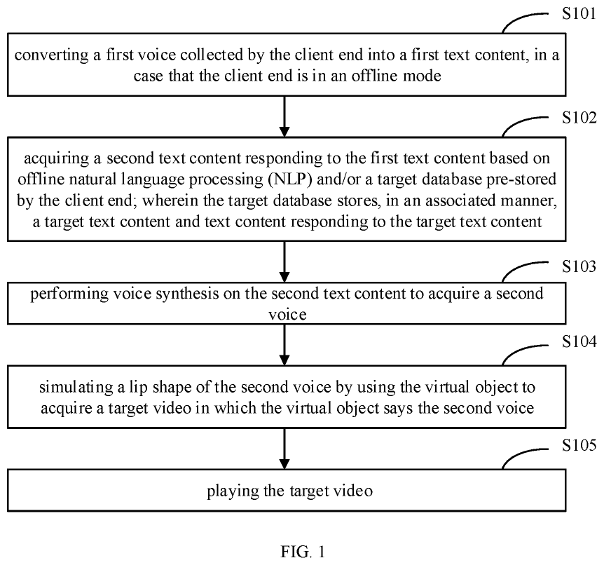

As shown in FIG. 1, the present application provides a method for dialogue with a virtual object, which includes the following steps:

step S101: converting a first voice collected by the client end into a first text content, in a case that the client end is in an offline mode.

In this embodiment, the method for dialogue with the virtual object involves computer technologies, and specifically involves the fields of artificial intelligence, natural language processing (NLP), knowledge graphs, computer visions, and voice technologies, which are applied to the client end.

The client end refers to a client end having an application that can conduct a real-time dialogue with the virtual object, that is, a terminal on which an application that can conduct a real-time dialogue with the virtual object is installed.

The conducting the real-time dialogue with the virtual object means that the virtual object can answer a question raised by a user, or respond to user's chat content in real time, thus forming a real-time dialogue process between the user and the virtual object. For example, the user says “hello”, correspondingly, the virtual object may respond “hello”. For another example, the user asks a question “how to find a certain item”, correspondingly, the virtual object may respond with a specific location of the item to guide the user.

The virtual object may be a virtual character, a virtual animal, or a virtual plant. In short, the virtual object refers to an object with a virtual image. The virtual character may be a cartoon character or a non-cartoon character.

The real-time conversation process may be presented to the user in a form of a video, and the video may include a playing image of the virtual object responding to the question posed by the user.

A user to be dialogued refers to a user who has a dialogue with a virtual object through the client end. The user to be dialogued may ask the client end a question in natural language, that is, the client end may speak the question he wants to ask in real time. Correspondingly, the client end may receive the first voice inputted by the user to be dialogued in real time, and then, in a case that the client end is in the offline mode, the client end may perform language recognition on the first voice, and generate the first text content. The first text content may refer to text description of the first voice inputted by the user to be dialogued, that is, semantic information of the first voice.

The client end being in the offline mode means that the client end is in a state of no network, disconnected network, weak network, or network congestion.

In a specific embodiment, the client end is in offline mode may adopt an existing or new automatic speech recognition (ASR) technology to recognize the first voice collected by the client end to acquire the first text content.

Step S102: acquiring a second text content responding to the first text content based on offline natural language processing (NLP) and/or a target database pre-stored by the client end; wherein the target database stores, in an associated manner, a target text content and text content responding to the target text content.

In this step, after acquiring the first text content, the client end may acquire, in offline manner, the second text content responding to the first text content based on the first text content.

The first text content is the text content of the question posed by the user to be dialogued, and the second text content may be an answer to the question posed by the user to be dialogued. The first text content is chat content of the user to be dialogued, and the second text content may be a content in response to the chat content.

There are many ways to acquire the second text content based on the first text content. For example, a target database may be pre-stored in the client end, and the target database has stored, in an associated manner, the target text content and the text content responding to the target text content.

The number of the target text content may be multiple, and the target text content may include at least one historical text content. The at least one historical text content may refer to all the questions raised by the user in a historical dialogue with the virtual object, or all the interactive contents of the user, or the at least one historical text content may refer to high-frequency question(s) raised by the user in a historical dialogue with the virtual object, or high-frequency interactive content(s) between the user and the virtual object.

The target text content may also include at least one predictive text content. The at least one predictive text content refers to predicted question(s) that the user may ask in some conversation scenarios and the answer(s) to the question(s), and may also include interactive contents of some daily conversations. For example, in a dialogue scene of item shopping guide, a user may ask a question “how to find a certain item”. For another example, in a dialogue scene of item maintenance, a user may ask a question “how to use a certain item”.

Correspondingly, the client end may acquire the second text content responding to the first text content from the target database.

For another example, the client end may perform offline natural language processing (NLP) on the first text content, to acquire the second text content in response to the first text content. The offline natural language processing (NLP) refers to natural language processing that is performed entirely on the client end and does not rely on the network.

For another example, the target database may be combined with the offline natural language processing (NLP), and if there is no text content in the target database that matches the second text content responding to the first text content, the offline natural language processing (NLP) may be performed on the first text content, to acquire the second text content.

Step S103: performing voice synthesis on the second text content to acquire a second voice.

In this step, an existing or new voice synthesis technique such as a text to speech (TTS) technology may be used to perform voice synthesis on the second text content to acquire a target file. The target file includes the second voice.

After removing a header file of the target file and the format of the target file, the second voice whose encoding format is Pulse Code Modulation (PCM) format can be obtained.

Step S104: simulating a lip shape of the second voice by using the virtual object to acquire a target video in which the virtual object says the second voice.

In this step, after acquiring the second voice, the client end uses the virtual object to simulate the lip shape of the second voice. Specifically, there may be two manners to use the virtual object to simulate the lip shape of the second voice. A first manner is that a pre-trained lip-shape prediction model may be stored on the client end. An input of the lip-shape prediction model may be the virtual object and the second voice. Correspondingly, an output of the lip-shape prediction model may be a plurality of target pictures in a process of the virtual object saying the second voice.

A second manner is that the client end may store lip shape pictures locally, where these lip shape pictures may be associated with voice. Accordingly, the lip shape of the second voice may be obtained by matching the second voice from locally stored lip shape pictures based on the second voice. A lip-shape simulation of the virtual object with respect to the second voice is performed based on the lip shape picture of the second voice, to acquire multiple target pictures in the process of the virtual object speaking the second voice.

The virtual object may be a virtual object in a virtual object library stored locally on the client end.

Subsequently, the client end may generate a target video based on the multiple target pictures obtained by lip-shape simulation. In the target video, a continuous change process of the lip shape during the virtual object says the second voice, and the audio signal of the second voice may be synthesized, so as to acquire a video in which the virtual object responds in real time to the first voice collected by the client end.

In order to make the generated target video more real and more vivid, the continuous change process of the lip shape during the virtual object says the second voice may be matched with the audio signal of the second voice, thereby avoiding a case that the lip shape during the virtual object says the second voice does not correspond to the audio, and truly reflecting the process of the virtual object making a speech on the second voice. In addition, the expression and action of the virtual object may be simulated during the virtual object makes a speech on the second voice, so that the dialogue between the user to be dialogued and the virtual object is more vivid and interesting.

Step S105: playing the target video.

After the target video is generated, a playback interface may be triggered or opened to play the target video.

Further, in the case that the user to be dialogued has not confirmed the end of the dialog, if the client end receives another first voice inputted by the user to be dialogued, in an optional embodiment, the client end in an offline mode may use the above steps and the virtual object to simulate a speech of a voice for responding to the first voice inputted by the user to be dialogued. In this application scenario, the above two dialogues belong to one complete dialogue process with the virtual object, and in this complete dialogue process, the user to be dialogued may interact with the virtual object multiple times, that is, the user to be dialogued may ask the virtual object a question for multiple times. Alternatively, multiple questions may also be asked to the virtual object at one time, and the virtual object may respond to the questions successively according to an order in which the questions are asked by the user to be dialogued.

In the case that the user to be dialogued has not confirmed the end of the dialog, if the client end receives another first voice inputted by the user to be dialogued, in another optional embodiment, the client end in an offline mode may use the above steps and use a new virtual object to simulate a speech of a voice for responding to the first voice inputted by the user to be dialogued, so as to acquire a new video and play it. In this application scenario, every time the user to be dialogued asks a question, it is a dialogue process with the virtual object, that is, an interaction between the user to be dialogued and the virtual object is realized.

Different virtual objects may be used to respond according to types of questions asked by the user to be dialogued. For example, when a question asked by the user to be dialogued is about shopping guide, a virtual object of the type of shopping guide may be used to have a dialogue with the user to be dialogued. For another example, when a question raised by the user to be dialogued is about item maintenance, a virtual object of the service supporter may be used to have a conversation with the user to be dialogued.

In a case that the user to be dialogued confirms to end the dialogue, the client end may automatically close the target video, to automatically close the dialogue process with the virtual object.

Of course, in the case that the user to be dialogued has not confirmed the end of the dialogue, when the user to be dialogued has not interacted with the virtual object for a long time, that is, when the client end has not received the first voice inputted by the user to be dialogued for a long time, the close of the target video may be triggered; or, the virtual object may be triggered to initiate a dialogue to prompt the user to be dialogued whether the dialogue still needs to be continued, and if there is no response, the target video is closed.

In the embodiments, in a case that the client end is in an offline mode, a first voice collected by the client end is converted into a first text content; a second text content responding to the first text content is acquired based on offline natural language processing (NLP) and/or a target database pre-stored by the client end; wherein the target database has stored a target text content and text content responding to the target text content that are associated with each other; voice synthesis is performed on the second text content to acquire a second voice; a lip shape of the second voice is simulated by using the virtual object to acquire a target video in which the virtual object says the second voice; and the target video is played.

In this way, when the client end is in an offline mode, the client end can complete, in an offline mode, the entire dialogue processes with the virtual object, which include: acquiring the first voice inputted by the user to be dialogued; converting the first voice into first text content based on automatic speech recognition (ASR); acquiring the second text content responding to the first text content based on offline natural language processing (NLP) and/or the target database pre-stored by the client end; synthesizing the second text content into the second voice based on voice synthesis TTS; and acquiring the virtual object and responding to the first voice by the virtual object according to the target video. In this way, it is able to avoid the use of a network to transmit a video about dialogue with the virtual object, so that the dialogue with virtual objects can be realized when the client end is in a scenario of no network, disconnected network, weak network, or network congestion. According to the technical solutions of the embodiments of the present application, the problem of network transmission during the dialogue with a virtual object is well solved, thereby improving the implementation effect of the dialogue with the virtual object.

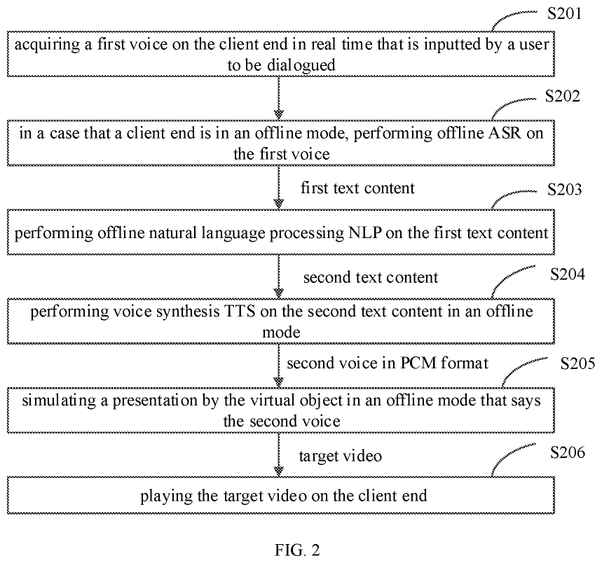

In order to better understand the solution of the present application, referring to FIG. 2, FIG. 2 is a schematic flowchart of processes implementing a method for dialogue with a virtual object according to an embodiment of the present application. As shown in FIG. 2, all the processes of dialogue with virtual objects are performed on a client end. Compared with a server, the processing by the client end may be deemed as offline processing. The processes implemented on the client end are as follows:

step S201: acquiring a first voice on the client end in real time that is inputted by a user to be dialogued;

step S202: in a case that a client end is in an offline mode, performing offline voice recognition (ASR) on the first voice, and outputting first text content;

step S203: performing offline natural language processing (NLP) on the first text content, and outputting second text content;

Of course, in this step, the second text content may also be queried in a target database based on the first text content; or, combined with the target database, if the second text content is not queried in the target database based on the first text content, the offline natural language processing (NLP) may be performed on the first text content, and the second text content is output.

Step S204: performing voice synthesis TTS on the second text content in an offline mode, and outputting a second voice in PCM format;

step S205: simulating a presentation by the virtual object in an offline mode that says the second voice, to generate the target video; and

step S206: playing the target video on the client end.

It can be seen that the above-mentioned dialogue processes between the user to be dialogued and the virtual object are realized on the client end. In this way, the network transmission problem in the process of dialogue with the virtual object can be solved well, and such dialogue can be achieved in environments of a weak network or no network, for example, in subway stations, shopping malls and banks.

Optionally, the step S102 specifically includes:

in a case that the first text content successfully matches the target text content stored in the target database, determining a text content associated with the target text content in the target database that successfully matches the first text content to be the second text content; or,

in a case that the first text content fails to match the target text content stored in the target database, performing the offline natural language processing (NLP) on the first text content to acquire the second text content; or,

performing the offline natural language processing (NLP) on the first text content to acquire the second text content.

In an embodiment, there may be three manners to acquire the second text content in an offline manner based on the first text content. A first manner is that a target database may be pre-stored in the client end, and the target database has stored, in an associated manner, the target text content and the text content responding to the target text content.

The number of the target text content may be multiple, and the target text content may include at least one historical text content. The at least one historical text content may refer to all the questions raised by the user in a historical dialogue with the virtual object, or all the interactive contents of the user, or the at least one historical text content may refer to high-frequency question(s) raised by the user in a historical dialogue with the virtual object, or high-frequency interactive content(s) between the user and the virtual object.

The target text content may also include at least one predictive text content. The at least one predictive text content refers to predicted question(s) that the user may ask in some conversation scenarios and the answer(s) to the question(s), and may also include interactive contents of some daily conversations. For example, in a dialogue scene of item shopping guide, a user may ask a question “how to find a certain item”. For another example, in a dialogue scene of item maintenance, a user may ask a question “how to use a certain item”.

Correspondingly, when the first text content is successfully matched with the target text content stored in the target database, the client end determines a text content associated with the target text content that is successfully matched with the first text content in the target database, to be the second text content.

A second manner is that the client end may perform offline natural language processing (NLP) on the first text content, to acquire the second text content in response to the first text content. The offline natural language processing (NLP) refers to natural language processing that is performed entirely on the client end and does not rely on the network

A third manner is to combine the target database with offline natural language processing (NLP). If the second text content responding to the first text content is not matched in the target database, the offline natural language processing (NLP) may be performed on the first text content to acquire the second text content.

In these embodiments, an answer to the first text content is obtained through offline natural language processing (NLP) to acquire the second text content, which can make the dialogue with the virtual object more intelligent. The acquiring the second text content based on the target database can use a data storage technology of the client end, which can save processing resources of the client end. Combining the two manners to acquire the second text content can not only save the processing resources of the client end, but also make the dialogue with the virtual object more intelligent.

Optionally, the step S104 specifically includes:

simulating, based on lip shape pictures that are locally stored, a lip shape when the virtual object says the second voice, to acquire a plurality of target pictures in a process of the virtual object saying the second voice;

processing the plurality of target pictures to acquire a video in which the lip shape continuously changes in the process of the virtual object saying the second voice; and

synthesizing the video in which the lip shape continuously changes and an audio signal of the second voice to acquire the target video.

In an embodiment, the client end may pre-store a picture of a virtual object. The picture of the virtual object is static, and usually the lips of the virtual object are close fitted. In order to achieve a more realistic effect of the virtual object, the lip shape of the virtual object saying the second voice may be simulated, to acquire multiple target pictures in the process of the virtual object says the second voice.

For example, if the second voice is “ [symbol] ” (Chinese word), a lip shape of the virtual object saying “ [symbol] ” is simulated first, to acquire at least one target picture in the process of saying “ [symbol] ”. Of course, in order to reflect the continuity of the lip shape, multiple target pictures may be acquired, for example, simulating the whole process of the mouth from closing to opening in the process of saying “ [symbol] ”, and acquiring multiple target pictures. Then, a lip shape of the virtual object saying “ [symbol] ” is simulated, and multiple target pictures may also be acquired. Finally, multiple target pictures in the process of the virtual object saying the second voice are acquired.

The multiple lip shape pictures may be stored locally by using the data storage technology of the client end, and these lip shape pictures may be associated with voices. Correspondingly, the lip shape picture of the second voice may be matched from these lip shape pictures, and based on the lip shape picture of the second voice, lip-shape simulation is performed on the virtual object with respect to the second voice, to acquire multiple target pictures in the process of the virtual object saying the second voice.

The multiple target pictures may be processed by a processing technology of picture-to-video synthesis. During the processing, the lip shape of the virtual object saying the second voice may be rendered, and finally, the video in which the lip shape continuously changes in the process of the virtual object saying the second voice is acquired.

It should be noted that there is no sound in the video in which the lip shape continuously changes, and the video in which the lip shape continuously changes and the audio signal of the second voice may be synthesized to acquire the target video. The target video reflects a scene where the virtual object actually or really speaks.

In addition, the continuous change process of the lip shape during the virtual object says the second voice may be matched with the audio signal of the second voice, thereby avoiding a case that the lip shape during the virtual object says the second voice does not correspond to the audio, and truly reflecting the process of the virtual object making a speech about the second voice. In addition, the expression and action of the virtual object may be simulated during the virtual object makes a speech about the second voice, so that the dialogue between the user to be dialogued and the virtual object is more vivid and interesting.

In an embodiment, by simulating the lip shape of the virtual object speaking the second voice, multiple target pictures in the process of the virtual object speaking the second voice are obtained; the multiple target pictures are processed to acquire a video in which the lip shape continuously changes during the virtual object speaks the second voice; and the video in which the lip shape changes continuously and the audio signal of the second voice are synthesized to acquire the target video. The target video embodies a scene where the virtual object actually speaks, which can make the dialogue between the user to be dialogued and the virtual object more real and vivid. In addition, by using the data storage technology of the client end, the lip shape of the virtual object saying the second voice is simulated based on the locally stored lip shape pictures, which can save the processing resources of the client end.

Optionally, prior to the step S101, the method further includes:

detecting a network transmission rate of the client end; and

determining that the client end is in an offline mode, in a case that the network transmission rate is lower than a preset value.

In this embodiment, when the first voice inputted by the user to be dialogued in real time is received, the network transmission rate of the client end may be detected. In a case that the network transmission rate is higher than or equal to the preset value, the first voice may be sent to a server, and the server generates a video about dialogue with a virtual object, and transmits it to the client end through a network for display.

In a case that the network transmission rate is lower than the preset value, the video of dialogue with the virtual object may be generated and played in an offline mode on the client end. The preset value may be set according to an actual situation. Usually, the preset value is set to be relatively small, so as to determine a case that the client end is in a situation of disconnected network, no network, weak network, or network congestion, and to generate and play the video of dialogue with the virtual object in an offline mode on the client end.

In this way, it can be ensured that in a case that the network quality is relatively good, powerful functions of a server can be used to find the answer to the first text content, so that the dialogue with the virtual object is more accurate and intelligent. In the case that a network is disconnected, weak or congested, or does not exist, the offline processing of the client end can be used to generate and play a video of dialogue with the virtual object. In this way, whether in a case of good network quality, or in a case of disconnected network, weak network, no network, or network congestion, the dialogue with virtual objects can be achieved. In one aspect, in a case that the network quality is relatively good, it can be guaranteed that the dialogue with the virtual object is more accurate and intelligent. In another aspect, in a case that the client end has a network problem, the stability of the dialogue with the virtual object can be ensured.

Optionally, prior to the step S104, the method further includes:

determining a type of the virtual object based on the first text content; and

selecting the virtual object of the type from a preset virtual object library.

In an embodiment, the type of the virtual object may be determined based on the first text content. Specifically, the type of the virtual object may be determined according to a type of a question asked by the user to be dialogued, and then the type of the virtual object may be selected from the preset virtual object library, so as to respond to the question by using different virtual objects.

The types of the virtual objects may be classified from multiple aspects. For classification from the perspective of identity, and the virtual objects may be classified into shopping guide and service supporter. For example, when a question asked by the to-be-dialogued user is about shopping guide, a virtual object of the type of shopping guide may be used to have a dialogue with the to-be-dialogued user. When a question raised by the to-be-dialogued user is about item maintenance, a virtual object of the type of service supporter may be used to have a dialogue with the to-be-dialogued user.

For classification from the perspective of character, the types may be divided into cartoon characters and non-cartoon characters. When a question asked by the to-be-dialogued user is about a game, the virtual object of the type of cartoon character may be used to have a dialogue with the to-be-dialogued user.

In addition, before simulating the second voice by using the virtual object, attribute information of the user to be dialogued may be obtained through a face recognition technology or voice recognition technology, and the attribute information may include age and gender, etc. Subsequently, a virtual object whose attribute matches the attribute information of the user to be dialogued may be selected from the preset virtual object library, based on the attribute information of the user to be dialogued.

The preset virtual object library may include not only multiple types of virtual objects, but also multiple attributes for the same type of virtual objects. For example, for a virtual object whose type is a shopping guide, the age attribute thereof may include 20 years old and 50 years old, etc., and the gender attribute may include male and female.

When selecting a virtual object, the virtual object may be selected in combination with the attribute information of the user to be dialogued. After the type of the virtual object is determined based on the first text content, the attribute information of the user to be dialogued may be matched with various attributes of the virtual objects of this type in the virtual object library, so as to select, from the virtual objects of this type, a virtual object whose attribute is similar to the attribute information of the user to be dialogued, as a virtual object for dialogue with the user to be dialogued. For example, if a user to be dialogued is a 25-year-old female, a virtual object whose age is 20 and gender is female may be selected from the virtual objects whose type is a shopping guide, to conduct a dialogue with the user to be dialogued. In this way, the dialogue can be made more lively and interesting, and the user experience can be improved.

### Second Embodiment

As shown in FIG. 3, the present application provides a device 300 for dialogue with a virtual object. The device is applied to a client end and includes:

a conversion module 301, configured to convert a first voice collected by the client end into a first text content, in a case that the client end is in an offline mode;

an acquisition module 302, configured to acquire a second text content responding to the first text content based on offline natural language processing (NLP) and/or a target database pre-stored by the client end; wherein the target database stores, in an associated manner, a target text content and a text content responding to the target text content;

a voice synthesis module 303, configured to perform voice synthesis on the second text content to acquire a second voice;

a lip shape simulation module 304, configured to simulate a lip shape of the second voice by using a virtual object to acquire a target video in which the virtual object says the second voice; and

a play module 305, configured to play the target video.

Optionally, the acquisition module 302 includes:

a determination unit, configured to, in a case that the first text content successfully matches the target text content stored in the target database, determine a text content associated with the target text content in the target database that successfully matches the first text content to be the second text content; or,

a first processing unit, configured to, in a case that the first text content fails to match the target text content stored in the target database, perform the offline natural language processing (NLP) on the first text content to acquire the second text content; or,

a second processing unit, configured to perform the offline natural language processing (NLP) on the first text content to acquire the second text content.

Optionally, the lip shape simulation module 304 includes:

a lip shape simulation unit, configured to simulate, based on lip shape pictures that are locally stored, a lip shape when the virtual object says the second voice, to acquire a plurality of target pictures in a process of the virtual object saying the second voice;

a picture processing unit, configured to process the plurality of target pictures to acquire a video in which the lip shape continuously changes in the process of the virtual object saying the second voice; and

an audio and video synthesis unit, configured to synthesize the video in which the lip shape continuously changes and an audio signal of the second voice to acquire the target video.

Optionally, the device further includes:

a detection module, configured to detect a network transmission rate of the client end; and

a first determination module, configured to determine that the client end is in an offline mode, in a case that the network transmission rate is lower than a preset value.

Optionally, the device further includes:

a second determination module, configured to determine a type of the virtual object based on the first text content; and

a selection module, configured to select the virtual object of the type from a preset virtual object library.

The device 300 for dialogue with a virtual object provided in the present application can implement each of the processes implemented in the embodiments of the method for dialogue with a virtual object described above, and can achieve the same beneficial effects. To avoid repetition, details are not repeated herein.

According to embodiments of the present application, the present application also provides a client end and a readable storage medium.

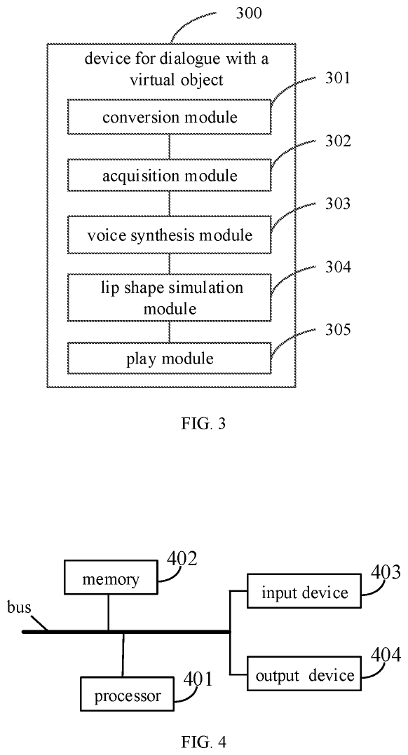

As shown in FIG. 4, it is a block diagram of a client end for implementing a method for dialogue with a virtual object according to an embodiment of the present application. The client end is intended to represent digital computers in various forms, such as a laptop computer, a desktop computer, a workstation, a personal digital assistant, a server, a blade server, a mainframe computer, and another suitable computer. The client end may further represent mobile devices in various forms, such as personal digital processing, a cellular phone, a smart phone, a wearable device, and another similar computing apparatus. The components shown herein, connections and relationships thereof, and functions thereof are merely examples, and are not intended to limit the implementations of the present application described and/or required herein.

As shown in FIG. 4, the client end includes one or more processors 401, a memory 402, and an interface for connecting various components, including a high-speed interface and a low-speed interface. The components are connected to each other by using different buses, and may be installed on a common motherboard or in other ways as required. The processor may process an instruction executed in the client end, including an instruction stored in or on the memory to display graphical information of a GUI on an external input/output device (such as a display device coupled to an interface). In another implementation, if necessary, a plurality of processors and/or a plurality of buses may be used together with a plurality of memories. Similarly, a plurality of client ends may be connected, and each device provides some necessary operations (for example, used as a server array, a group of blade servers, or a multi-processor system). In FIG. 4, one processor 401 is used as an example.

The memory 402 is a non-transitory computer-readable storage medium provided in the present application. The memory stores an instruction that can be executed by at least one processor to perform the method for dialogue with the virtual object provided in the present application. The non-transitory computer-readable storage medium in the present application stores a computer instruction, and the computer instruction is executed by a computer to implement the method for dialogue with the virtual object provided in the present application.

As a non-transitory computer-readable storage medium, the memory 402 may be used to store a non-transitory software program, a non-transitory computer-executable program, and a module, such as a program instruction/module corresponding to the method for dialogue with the virtual object in the embodiment of the present application (for example, the conversion module 301, the acquisition module 302, the voice synthesis module 303, the lip shape simulation module 304 and the play module 305 shown in FIG. 3). The processor 401 executes various functional applications and data processing of the server by running the non-transient software program, instruction, and module that are stored in the memory 402, that is, implementing the method for dialogue with the virtual object in the foregoing method embodiments.

The memory 402 may include a program storage area and a data storage area. The program storage area may store an operating system and an application program required by at least one function. The data storage area may store data created based on use of a client end. In addition, the memory 402 may include a high-speed random access memory, and may further include a non-transitory memory, such as at least one magnetic disk storage device, a flash memory device, or other non-transitory solid-state storage devices. In some embodiments, the memory 402 may optionally include a memory remotely provided with respect to the processor 401, and these remote memories may be connected, through a network, to the client end. Examples of the network include, but are not limited to, the Internet, the Intranet, a local area network, a mobile communication network, and a combination thereof

The client end for implementing the method for dialogue with the virtual object may further include: an input device 403 and an output device 404. The processor 401, the memory 402, the input device 403, and the output device 404 may be connected by a bus or in other ways. In FIG. 4, a bus for connection is used as an example.

The input device 403 may receive digital or character information that is inputted, and generate key signal input related to a user setting and function control of the client end for implementing the method for dialogue with the virtual object, such as a touch screen, a keypad, a mouse, a trackpad, a touchpad, and a pointing stick, one or more mouse buttons, a trackball, a joystick, or another input device. The output device 404 may include a display device, an auxiliary lighting apparatus (for example, an LED), a tactile feedback apparatus (for example, a vibration motor), and the like. The display device may include, but is not limited to, a liquid crystal display (LCD), a light emitting diode (LED) display, and a plasma display. In some implementations, the display device may be a touch screen.

The various implementations of the system and technology described herein may be implemented in a digital electronic circuit system, an integrated circuit system, an application specific integrated circuit (ASIC), computer hardware, firmware, software, and/or a combination thereof. The various implementations may include: implementation in one or more computer programs that may be executed and/or interpreted by a programmable system including at least one programmable processor. The programmable processor may be a dedicated or general-purpose programmable processor, and may receive data and instructions from a storage system, at least one input device and at least one output device, and transmit the data and the instructions to the storage system, the at least one input device and the at least one output device.

These computing programs (also referred to as programs, software, software applications, or codes) include machine instructions of a programmable processor, and may be implemented by using procedure-oriented and/or object-oriented programming language, and/or assembly/machine language. As used herein, the terms “machine-readable medium” and “computer-readable medium” refer to any computer program product, apparatus, and/or device (e.g., a magnetic disk, an optical disc, a memory, a programmable logic device (PLD)) for providing machine instructions and/or data to a programmable processor, including a machine-readable medium that receives machine instructions implemented as machine-readable signals. The term “machine-readable signal” refers to any signal used to provide machine instructions and/or data to a programmable processor.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique described herein), or that includes any combination of such back-end component, middleware component, or front-end component. The components of the system can be interconnected in digital data communication (e.g., a communication network) in any form or medium. Examples of communication network include a local area network (LAN), a wide area network (WAN) and the Internet.

A computer system may include a client and a server. The client and the server are generally far away from each other and usually interact through a communication network. The relationship between client and server arises by virtue of computer programs running on respective computers and having a client-server relationship with each other.

In the embodiments, when the client end is in an offline mode, the client end can complete, in an offline mode, the entire dialogue processes with the virtual object, which include: acquiring the first voice inputted by the user to be dialogued; converting the first voice into first text content based on automatic speech recognition (ASR); acquiring the second text content responding to the first text content based on offline natural language processing (NLP) and/or the target database pre-stored by the client end; synthesizing the second text content into the second voice based on voice synthesis TTS; and acquiring the virtual object and responding to the first voice by the virtual object according to the target video. In this way, it is able to avoid the use of a network to transmit a video about dialogue with the virtual object, so that the dialogue with virtual objects can be realized when the client end is in a scenario of no network, disconnected network, weak network, or network congestion. According to the technical solutions of the embodiments of the present application, the problem about network transmission during the dialogue with a virtual object is well solved, thereby improving the effect of the dialogue with the virtual object.

It may be appreciated that, all forms of processes shown above may be used, and steps thereof may be reordered, added or deleted. For example, as long as expected results of the technical solutions of the present application can be achieved, steps set forth in the present application may be performed in parallel, in sequence, or in a different order, and there is no limitation in this regard.

The foregoing specific implementations constitute no limitation onto the protection scope of the present application. It is appreciated by those skilled in the art that various modifications, combinations, sub-combinations and replacements can be made according to design requirements and other factors. Any modifications, equivalent replacements and improvements made without deviating from the spirit and the principle of the present application shall fall within the protection scope of the present application.

What is claimed is:

1. A method for dialogue with a virtual object, applied to a client end and comprising:
converting a first voice collected by the client end into a first text content, in a case that the client end is in an offline mode;
acquiring a second text content responding to the first text content based on offline natural language processing (NLP) and/or a target database pre-stored by the client end; wherein the target database stores, in an associated manner, a target text content and a text content responding to the target text content;
performing voice synthesis on the second text content to acquire a second voice;
simulating a lip shape of the second voice by using the virtual object to acquire a target video in which the virtual object says the second voice; and
playing the target video.

2. The method according to claim 1, wherein the acquiring the second text content responding to the first text content based on the offline natural language processing (NLP) and/or the target database pre-stored by the client end comprises:
in a case that the first text content successfully matches the target text content stored in the target database, determining a text content associated with the target text content in the target database that successfully matches the first text content to be the second text content; or,
in a case that the first text content fails to match the target text content stored in the target database, performing the offline natural language processing (NLP) on the first text content to acquire the second text content; or,
performing the offline natural language processing (NLP) on the first text content to acquire the second text content.

3. The method according to claim 1, wherein the simulating the lip shape of the second voice by using the virtual object to acquire the target video in which the virtual object says the second voice comprises:
simulating, based on lip shape pictures that are locally stored, a lip shape when the virtual object says the second voice, to acquire a plurality of target pictures in a process of the virtual object saying the second voice;
processing the plurality of target pictures to acquire a video in which the lip shape continuously changes in the process of the virtual object saying the second voice; and
synthesizing the video in which the lip shape continuously changes and an audio signal of the second voice to acquire the target video.

4. The method according to claim 1, wherein before converting the first voice collected by the client end into the first text content, in a case that the client end is in the offline mode, the method further comprises:
detecting a network transmission rate of the client end; and
determining that the client end is in the offline mode, in a case that the network transmission rate is lower than a preset value.

5. The method according to claim 1, wherein before simulating the lip shape of the second voice by using the virtual object to acquire the target video in which the virtual object says the second voice, the method further comprises:
determining a type of the virtual object based on the first text content; and
selecting the virtual object of the type from a preset virtual object library.

6. A device for dialogue with a virtual object, applied to a client end and comprising:
at least one processor; and
a memory communicatively connected to the at least one processor; wherein the memory stores an instruction executable by the at least one processor, and when executing the instruction, the at least one processor is configured to:
convert a first voice collected by the client end into a first text content, in a case that the client end is in an offline mode;
acquire a second text content responding to the first text content based on offline natural language processing (NLP) and/or a target database pre-stored by the client end; wherein the target database stores, in an associated manner, a target text content and a text content responding to the target text content;
perform voice synthesis on the second text content to acquire a second voice;
simulate a lip shape of the second voice by using the virtual object to acquire a target video in which the virtual object says the second voice; and
play the target video.

7. The device according to claim 6, wherein the at least one processor is further configured to:
in a case that the first text content successfully matches the target text content stored in the target database, determine a text content associated with the target text content in the target database that successfully matches the first text content to be the second text content; or,
in a case that the first text content fails to match the target text content stored in the target database, perform the offline natural language processing (NLP) on the first text content to acquire the second text content; or,
perform the offline natural language processing (NLP) on the first text content to acquire the second text content.

8. The device according to claim 6, wherein the at least one processor is further configured to:
simulate, based on lip shape pictures that are locally stored, a lip shape when the virtual object says the second voice, to acquire a plurality of target pictures in a process of the virtual object saying the second voice;
process the plurality of target pictures to acquire a video in which the lip shape continuously changes in the process of the virtual object saying the second voice; and
synthesize the video in which the lip shape continuously changes and an audio signal of the second voice to acquire the target video.

9. The device according to claim 6, wherein the at least one processor is further configured to:
detect a network transmission rate of the client end; and
determine that the client end is in the offline mode, in a case that the network transmission rate is lower than a preset value.

10. The device according to claim 6, wherein the at least one processor is further configured to:
determine a type of the virtual object based on the first text content; and
select the virtual object of the type from a preset virtual object library.

11. A non-transitory computer-readable storage medium, storing a computer instruction thereon, wherein the computer instruction is configured to be executed to cause a computer to perform following steps:
converting a first voice collected by a client end into a first text content, in a case that the client end is in an offline mode;
acquiring a second text content responding to the first text content based on offline natural language processing (NLP) and/or a target database pre-stored by the client end; wherein the target database stores, in an associated manner, a target text content and a text content responding to the target text content;
performing voice synthesis on the second text content to acquire a second voice;
simulating a lip shape of the second voice by using a virtual object to acquire a target video in which the virtual object says the second voice; and
playing the target video.

12. The non-transitory computer-readable storage medium according to claim 11, wherein when acquiring the second text content responding to the first text content based on the offline natural language processing (NLP) and/or the target database pre-stored by the client end, the computer instruction is further configured to be executed to cause the computer to perform following steps:
in a case that the first text content successfully matches the target text content stored in the target database, determining a text content associated with the target text content in the target database that successfully matches the first text content to be the second text content; or,
in a case that the first text content fails to match the target text content stored in the target database, performing the offline natural language processing (NLP) on the first text content to acquire the second text content; or,
performing the offline natural language processing (NLP) on the first text content to acquire the second text content.

13. The non-transitory computer-readable storage medium according to claim 11, wherein when simulating the lip shape of the second voice by using the virtual object to acquire the target video in which the virtual object says the second voice, the computer instruction is further configured to be executed to cause the computer to perform following steps:
simulating, based on lip shape pictures that are locally stored, a lip shape when the virtual object says the second voice, to acquire a plurality of target pictures in a process of the virtual object saying the second voice;
processing the plurality of target pictures to acquire a video in which the lip shape continuously changes in the process of the virtual object saying the second voice; and
synthesizing the video in which the lip shape continuously changes and an audio signal of the second voice to acquire the target video.

14. The non-transitory computer-readable storage medium according to claim 11, wherein before converting the first voice collected by the client end into the first text content, in a case that the client end is in the offline mode, the computer instruction is configured to be executed to cause the computer to perform following steps:
detecting a network transmission rate of the client end; and
determining that the client end is in the offline mode, in a case that the network transmission rate is lower than a preset value.

15. The non-transitory computer-readable storage medium according to claim 11, wherein before simulating the lip shape of the second voice by using the virtual object to acquire the target video in which the virtual object says the second voice, the computer instruction is configured to be executed to cause the computer to perform following steps:
determining a type of the virtual object based on the first text content; and
selecting the virtual object of the type from a preset virtual object library.
